(19) United States
(12) Patent Application Publication
(10) Pub. No.: US 2007/0270048 A1
(43) Pub. Date: Nov. 22, 2007

(54) Terminal structure and connecting method thereof

(75) Inventors: Chung-kai Lan, Taoyuan Hsien (TW); Hung-Chi Chen, Taoyuan Hsien (TW); Te-Tsai Chuang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/702,637

(22) Filed: Feb. 6, 2007

(30) Foreign Application Priority Data
May 22, 2006 (TW) 095118119

(51) Int. Cl. H01R 4/02

(52) U.S. Cl. 439/874

(57) ABSTRACT

A terminal structure is fixed to a circuit board for electrically connecting a wire with the circuit board. The terminal structure includes a fixing part and a connecting part. The fixing part is fixed to the circuit board. The connecting part is connected with the fixing part to be electrically connected with the wire. A connecting method of the terminal structure is also disclosed.

### CROSS REFERENCE TO RELATED APPLICATIONS

This Non-provisional application claims priority under 35 U.S.C. §119(a) on Patent Application No(s). 095118119 filed in Taiwan, Republic of China on May 22, 2006, the entire contents of which are hereby incorporated by reference.

### BACKGROUND OF THE INVENTION

1. Field of Invention

The invention relates to a terminal structure and the connecting method thereof, and more particularly, to a terminal structure enabling an electrical connection between a circuit board and a wire and the connecting method thereof.

2. Related Art

As shown in FIGS. 1A and 1B, the connection between a circuit board 6 of a brushless motor and a wire 5, such as the enameled wire, is achieved by directly soldering the enameled wire 5 onto the circuit board 6 or inserting the enameled wire 5 through the circuit board 6 followed by soldering with a solder s. However, the conventional connecting method often encounters bending stresses at the connecting points as indicated by the dashed circles A and B in the drawings. The enameled wire 5 is likely to break due to vibrations or pulling, or may easily depart from the circuit board 6 when the pad thereon becomes loose. The above-mentioned connecting method is generally suitable for ordinary enameled wire that can convey small currents. When the enameled wire 5 is a polyethylene enameled wire (PEW) that is more thermal-resistant or a nylon-coated PEW (PEW+NY) prepared in a leadless process, it is impossible to remove the covering layer of the enameled wire 5 by heating it in a tinning furnace. The covering layer has to be removed by employing some chemicals or cutting tools. Not only does this incur the cost of extra time spent and processes, but the result is not consistently reliable. Moreover, soldering via the conventional method may result in an unstable connection between the circuit board 6 and the enameled wire 5, decreasing the reliability of the products.

Therefore, it is important to provide a terminal structure such that the wire and the circuit board have a good electrical connection.

### SUMMARY OF THE INVENTION

In view of the foregoing, the invention is to provide a terminal structure and a connecting method thereof to prevent a wire from bending at its connecting part with the circuit board. The wire thus does not break due to vibrations or pulling, or depart from the circuit board as the pad becomes loose.

To achieve the above, the invention discloses a terminal structure fixed on a circuit board to provide an electrical connection between a wire and the circuit board. The terminal structure includes a fixing part and a connecting part. The fixing part is fixed to the circuit board, and the connecting part is connected with the fixing part and electrically connected to the wire.

To achieve the above, the invention also discloses a connecting method of a terminal structure including a fixing part and a connecting part. The method includes the steps of: providing a circuit board fixed with the terminal structure and a wire; fixing the fixing part to the circuit board; fixing the wire to the connecting part; and electrically connecting the wire with the circuit.

As mentioned above, the terminal structure and connecting method thereof achieve an electrical connection between a wire and a circuit board using a connecting part that tightly holds or is soldered to the wire. In comparison with the prior art, the invention prevents the wire from bending at the connecting part. When the wire is applied to the high temperature leadless processes or is covered with an insulating material, no additional step for removing the enamel paint is needed before soldering. The high temperature produced by the soldering does not have negative effects on the circuit board. Accordingly, the reliability of electrical connections is also much greater than in the prior art.

### BRIEF DESCRIPTION OF THE DRAWINGS

The invention will become more fully understood from the detailed description given herein below illustration only, and thus is not limitative of the present invention, and wherein:

FIGS. 1A and 1B are schematic views showing the connection between a circuit board and a wire in the prior art;

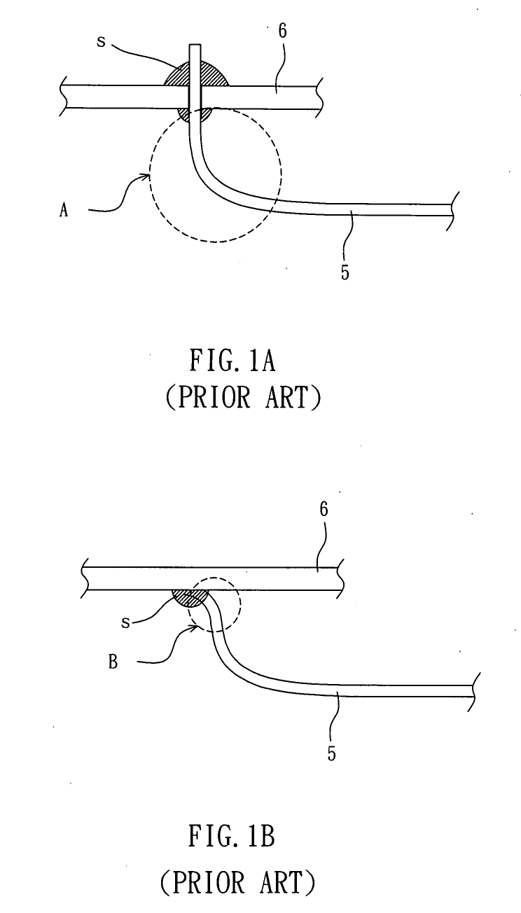

FIG. 2 is a schematic view of a terminal structure according to an embodiment of the invention;

FIG. 3 is another schematic view of the disclosed terminal structure;

FIG. 4 is a schematic view of another terminal structure of the invention; and

FIG. 5 is a flowchart of the disclosed connecting method of a terminal structure.

### DETAILED DESCRIPTION OF THE INVENTION

The present invention will be apparent from the following detailed description, which proceeds with reference to the accompanying drawings, wherein the same references relate to the same elements.

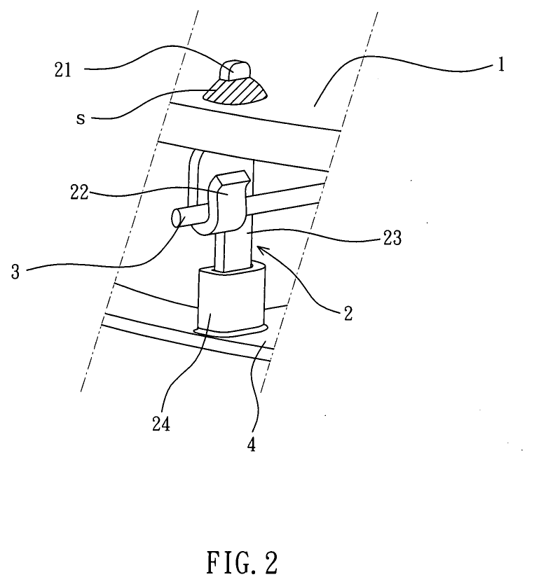

With reference to FIG. 2, the terminal structure 2 according to an embodiment of the invention is fixed on a circuit board 1 for a wire 3 to be electrically connected to the circuit board 1 via the terminal structure 2. The terminal structure 2 includes a fixing part 21 and a connecting part 22. The fixing part 21 is fixed on the circuit board 1 using a solder s. The fixing part 21 and the connecting part 22 are formed as a single piece and made of a conductive material such as metal or alloy. The connecting part 22 has a bend for holding the wire 3. The wire 3 is thus electrically connected to the circuit board 1 via the terminal structure 2. The wire 3 is prevented from bending at the connecting part 22. The wire 3 can be a wire coil inside a motor or the wire of an external system.

The terminal structure 2 further includes a supporting part 23. The supporting part 23 is connected with the fixing part 21 and/or the connecting part 22 to provide a support for the fixing part 21 and the connecting part 22. The fixing part 21, the connecting part 22, and the supporting part 23 are formed as a single piece. Since the supporting part 23 is made of a conductive material, it is covered by an insulating material 24 to prevent the terminal structure 2 from electrical connections with other conductive devices. In this embodiment, the supporting part 23 is disposed on a base 4 by gluing.

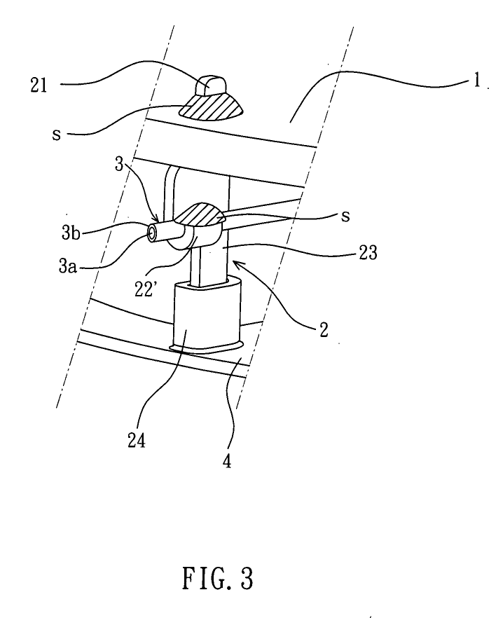

FIG. 3 shows an embodiment of using the disclosed terminal structure 2 in the electrical connection between the circuit board 1 and the enameled wire. As shown in FIG. 3, the wire 3 is an enameled wire. That is, the wire 3 includes a metal core 3a covered by an insulating material 3b. The wire 3 can be fixed to a connecting part 22′ of the terminal structure 2 by spot soldering. In this embodiment, the wire is an enameled wire and connected to the connecting part 22′ by spot soldering. The temperature generated by spot soldering does not cause any negative effect to the circuit board 1. The high temperature generated by spot soldering just melts the insulating material 3b covering the wire, so that an electrical connection is established between the wire 3 and the connecting part 22′. Thus, it is unnecessary to employ an additional step for removing the enamel paint of the enameled wire.

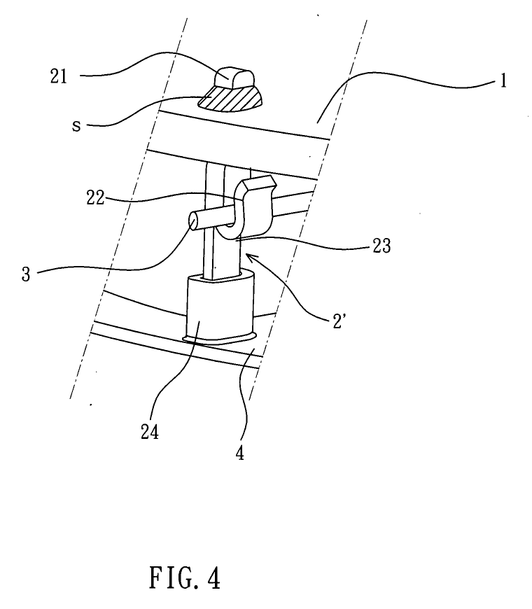

As shown in FIG. 4, another terminal structure 2′ of the invention includes a fixing part 21, a connecting part 22, a supporting part 23, and an insulator 24. The difference of this embodiment from the previous one is in that the fixing part 21, the connecting part 22, and the supporting part 23 of the terminal structure 2′ are formed as a single piece, and positioned on the same axial line. It also prevents the wire 3 from bending at the connecting part 22. The compositions and functions of the fixing part 21, the connecting part 22, the supporting part 23, and the insulator 24 are the same as the previous embodiment, and are not further described herein.

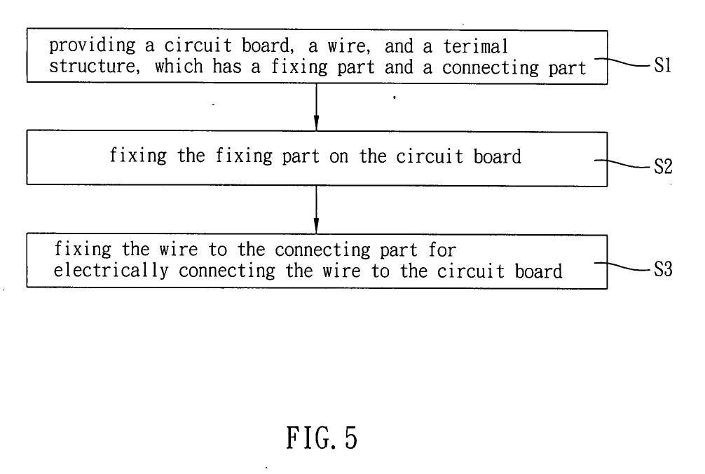

With reference to FIG. 5, the connecting method of a terminal structure 2 according to an embodiment of the invention includes steps S1 through S3. In step S1, a circuit board 1, a wire 3, and a terminal structure 2 including a fixing part 21 and a connecting part 22 are provided. In step S2, the fixing part 21 is fixed on the circuit board 1. Finally, in step S3, the wire 3 is fixed to the connecting part 22 for the wire 3 to be electrically connected to the circuit board 1. The order of step S2 and step S3 can be interchanged. The wire 3 and the circuit board 1 likewise have an indirect electrical connection in this case, thus avoiding any negative effects of high-temperature soldering on the circuit board 1.

In summary, the terminal structure and connecting method thereof achieve an electrical connection between a wire and a circuit board using a connecting part that tightly holds or is soldered to the wire. In comparison with the prior art, the method of the invention can be applied to leadless processes. When the wire is covered with an insulating material, no additional step for removing the enamel paint is needed before soldering. The high temperature produced by the soldering does not have negative effects on the circuit board. The connecting method of using the disclosed terminal structure can reduce the risk of possible damages to the circuit board. The reliability of electrical connections is also much greater than in the prior art.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A terminal structure fixed on a circuit board for electrically connecting a wire to the circuit board, comprising:
a fixing part fixed on the circuit board; and
a connecting part connected to the fixing part and electrically connected to the wire.

2. The terminal structure of claim 1, wherein the fixing part and the connecting part are formed as a single piece.

3. The terminal structure of claim 1, wherein the connecting part has a bend to hold the wire so that the wire is fixed to the connecting part by holding or soldering.

4. The terminal structure of claim 1, wherein the wire is an enameled wire.

5. The terminal structure of claim 4, wherein the wire is a coil in a motor or a connecting wire of an external system.

6. The terminal structure of claim 1, wherein the terminal structure is made of a metal, an alloy, or a conductive material.

7. The terminal structure of claim 1, further comprising a supporting part connected to the fixing part and/or the connecting part.

8. The terminal structure of claim 7, wherein the supporting part is fixed on a base.

9. The terminal structure of claim 7, wherein the supporting part is covered with an insulating material.

10. The terminal structure of claim 7, wherein the fixing part, the connecting part, and the supporting part are formed as a single piece and positioned on the same axial line.

11. A connecting method of a terminal structure, comprising the steps of:
providing a circuit board, a wire, and a terminal structure, wherein the terminal structure includes a fixing part and a connecting part;
fixing the fixing part to the circuit board; and
fixing the wire to the connecting part for electrically connecting the wire to the circuit board.

12. The connecting method of claim 11, wherein the fixing part and the connecting part are formed as a single piece.

13. The connecting method of claim 11, wherein the connecting part has a bend to hold the wire so that the wire is fixed to the connecting part by holding or soldering.

14. The connecting method of claim 11, wherein the wire is an enameled wire.

15. The connecting method of claim 11, wherein the terminal structure is made of a metal, an alloy, or a conductive material.

16. The connecting method of claim 11, wherein the terminal further comprises a supporting part connected to the fixing part and/or the connecting part.

17. The connecting method of claim 16, wherein the supporting part is fixed on a base.

18. The connecting method of claim 16, wherein the supporting part is covered with an insulating material.

19. The connecting method of claim 16, wherein the fixing part, the connecting part, and the supporting part are formed as a single piece and positioned on the same axial line.
